(19) United States
(12) Patent Application Publication
(10) Pub. No.: US 2026/0362541 A1
(43) Pub. Date: Nov. 12, 2026

(54) TECHNIQUES FOR PERIODIC PARAMETER ADAPTATION CONFIGURATION

(71) Applicant: QUALCOMM Incorporated, San Diego, CA (US)

(72) Inventors: Gabi SARKIS, San Diego, CA (US); Diana MAAMARI, San Diego, CA (US); Peter GAAL, San Diego, CA (US); Jing JIANG, San Diego, CA (US)

(21) Appl. No.: 19/201,151

(22) Filed: May 7, 2025

(51) Int. Cl. H04W 76/28

(52) U.S. Cl. CPC H04W 76/28

(57) ABSTRACT

Various aspects of the present disclosure generally relate to wireless communication. In some aspects, a user equipment (UE) may receive configuration information, the configuration information indicating periodically adapting one or more first scheduling parameters, the one or more first scheduling parameters associated with a configuration period, the configuration period including an active duration and an inactive duration. The UE may communicate, during the active duration, in accordance with the one or more first scheduling parameters. The UE may communicate, during the inactive duration, in accordance with one or more second scheduling parameters that are different from the one or more first scheduling parameters. Numerous other aspects are described.

### FIELD OF THE DISCLOSURE

Aspects of the present disclosure generally relate to wireless communication and specifically relate to techniques, apparatuses, and methods associated with periodic parameter adaptation configuration.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, a user equipment (UE) may operate in association with a discontinuous reception (DRX) configuration (for example, indicated to the UE by a network node). DRX operation may enable the UE to enter a sleep mode at various times while in the coverage area of a network node to reduce power consumption for conserving battery resources, among other examples. The DRX configuration generally configures the UE to operate in association with a DRX cycle. The UE may repeat DRX cycles with a configured periodicity according to the DRX configuration. A DRX cycle may include a DRX on duration during which the UE is in an awake mode or in an active state. A DRX cycle may also include one or more durations during which the UE may operate in an inactive state. The one or more durations may be opportunities for the UE to enter a DRX sleep mode in which the UE may refrain from monitoring for communications from a network node. Additionally, or alternatively, the UE may deactivate one or more antennas, radio frequency chains, or other hardware components or devices while operating in the DRX sleep mode.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include processor circuitry and code-storing memory circuitry. The processing system may be configured to cause the UE to receive configuration information, the configuration information indicating periodically adapting one or more first scheduling parameters, the one or more first scheduling parameters associated with a configuration period, the configuration period including an active duration and an inactive duration. The processing system may be configured to cause the UE to communicate, during the active duration, in accordance with the one or more first scheduling parameters. The processing system may be configured to cause the UE to communicate, during the inactive duration, in accordance with one or more second scheduling parameters that are different from the one or more first scheduling parameters.

Some aspects described herein relate to a network node. The network node may include a processing system. The processing system may include processor circuitry and code-storing memory circuitry. The processing system may be configured to cause the network node to transmit configuration information, the configuration information indicating periodically adapting one or more first scheduling parameters, the one or more first scheduling parameters associated with a configuration period, the configuration period including an active duration and an inactive duration. The processing system may be configured to cause the network node to communicate, during the active duration, in accordance with the one or more first scheduling parameters. The processing system may be configured to cause the network node to communicate, during the inactive duration, in accordance with one or more second scheduling parameters that are different from the one or more first scheduling parameters.

Some aspects described herein relate to a method of wireless communication performed by a UE. The method may include receiving configuration information, the configuration information indicating periodically adapting one or more first scheduling parameters, the one or more first scheduling parameters associated with a configuration period, the configuration period including an active duration and an inactive duration. The method may include communicating, during the active duration, in accordance with the one or more first scheduling parameters. The method may include communicating, during the inactive duration, in accordance with one or more second scheduling parameters that are different from the one or more first scheduling parameters.

Some aspects described herein relate to a method of wireless communication performed by a network node. The method may include transmitting configuration information, the configuration information indicating periodically adapting one or more first scheduling parameters, the one or more first scheduling parameters associated with a configuration period, the configuration period including an active duration and an inactive duration. The method may include communicating, during the active duration, in accordance with the one or more first scheduling parameters. The method may include communicating, during the inactive duration, in accordance with one or more second scheduling parameters that are different from the one or more first scheduling parameters.

Some aspects described herein relate to an apparatus for wireless communication. The apparatus may include means for receiving configuration information, the configuration information indicating periodically adapting one or more first scheduling parameters, the one or more first scheduling parameters associated with a configuration period, the configuration period including an active duration and an inactive duration. The apparatus may include means for communicating, during the active duration, in accordance with the one or more first scheduling parameters. The apparatus may include means for communicating, during the inactive duration, in accordance with one or more second scheduling parameters that are different from the one or more first scheduling parameters.

Some aspects described herein relate to an apparatus for wireless communication. The apparatus may include means for transmitting configuration information, the configuration information indicating periodically adapting one or more first scheduling parameters, the one or more first scheduling parameters associated with a configuration period, the configuration period including an active duration and an inactive duration. The apparatus may include means for communicating, during the active duration, in accordance with the one or more first scheduling parameters. The apparatus may include means for communicating, during the inactive duration, in accordance with one or more second scheduling parameters that are different from the one or more first scheduling parameters.

Some aspects described herein relate to a non-transitory computer-readable medium that stores a set of instructions for wireless communication by a UE. The set of instructions, when executed by one or more processors of the UE, may cause the UE to receive configuration information, the configuration information indicating periodically adapting one or more first scheduling parameters, the one or more first scheduling parameters associated with a configuration period, the configuration period including an active duration and an inactive duration. The set of instructions, when executed by one or more processors of the UE, may cause the UE to communicate, during the active duration, in accordance with the one or more first scheduling parameters. The set of instructions, when executed by one or more processors of the UE, may cause the UE to communicate, during the inactive duration, in accordance with one or more second scheduling parameters that are different from the one or more first scheduling parameters.

Some aspects described herein relate to a non-transitory computer-readable medium that stores a set of instructions for wireless communication by a network node. The set of instructions, when executed by one or more processors of the network node, may cause the network node to transmit configuration information, the configuration information indicating periodically adapting one or more first scheduling parameters, the one or more first scheduling parameters associated with a configuration period, the configuration period including an active duration and an inactive duration. The set of instructions, when executed by one or more processors of the network node, may cause the network node to communicate, during the active duration, in accordance with the one or more first scheduling parameters. The set of instructions, when executed by one or more processors of the network node, may cause the network node to communicate, during the inactive duration, in accordance with one or more second scheduling parameters that are different from the one or more first scheduling parameters.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of a discontinuous reception (DRX) configuration.

FIG. 3 is a diagram illustrating an example of communication configuration adaptation.

FIG. 4 is a diagram illustrating an example associated with signaling for periodic parameter adaptation configuration.

FIG. 5 is a diagram illustrating an example associated with periodic parameter adaptation configuration.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIG. 8 is a diagram of an example apparatus for wireless communication.

FIG. 9 is a diagram of an example apparatus for wireless communication.

### DETAILED DESCRIPTION

In some examples, user equipment (UE) parameters may be adapted (e.g., changed or switched) with or without a radio resource control (RRC) reconfiguration. For example, a bandwidth part (BWP) may be adapted using downlink control information (DCI) signaling or an RRC reconfiguration, and various parameters corresponding to the BWP (e.g., bandwidth, sub-carrier spacing (SCS), a modulation and coding scheme (MCS) table, a channel state information (CSI) configuration, maximum rank, or the like) may correspondingly switch. Additionally, or alternatively, a minimum scheduling offset parameter K0 or a minimum scheduling offset parameter K2 may be adapted. A minimum scheduling offset parameter K0 is a minimum time window between a physical downlink control channel (PDCCH) communication that schedules a physical downlink shared channel (PDSCH) communication, and the PDSCH communication. A minimum scheduling offset parameter K2 is a minimum time window between a PDCCH communication that schedules a physical uplink shared channel (PUSCH) communication, and the PUSCH communication. In some examples, possible values for the minimum scheduling offset parameter K0 or the minimum scheduling offset parameter K2 may be configured per BWP, and a UE may receive DCI indicating which value(s) is/are active.

In some examples, a UE may be configured with multiple (e.g., two) per-BWP communication configurations. A per-BWP communication configuration may provide a mechanism for fast and robust UE bandwidth adaptation. For example, a per-BWP communication configuration may correspond to one or more parameters, such as a maximum bandwidth, a maximum rank, a minimum timeline, a search space (SS) periodicity, or the like. The per-BWP communication configuration may be configured for a BWP for a PDCCH, a PDSCH, a random access channel (RACH), a PUSCH, a sounding reference signal (SRS), or the like. The per-BWP communication configuration may be referred to as an “adaptation profile,” “a sub-BWP,” or the like. In some examples, the UE may alternate between active per-BWP communication configurations. For example, UE may receive DCI indicating which per-BWP communication configuration is active.

Adaptation of UE configurations, such as for BWPs, minimum scheduling offset parameter K0 or minimum scheduling offset parameter K2, or per-BWP communication configuration, involves explicit signaling, such as DCI signaling. However, using DCI signaling for every adaptation instance consumes overhead. For example, each DCI communication consumes one or more time and frequency resources, and DCI may consume more resources as the number of adaptations increases. Additionally, or alternatively, DCI signaling may incur latency due to a minimum time window for the UE to adapt one or more parameters in accordance with the DCI.

Various aspects relate generally to reducing DCI signaling for adaptation. Some aspects more specifically relate to periodically adapting scheduling parameters. In some aspects, a UE may periodically adapt one or more scheduling parameters during active and inactive durations within a configuration period. In some examples, the UE may receive configuration information that specifies the scheduling parameters, the configuration period, the active duration, the inactive duration, or the like. For example, the configuration information may enable periodic adaptation at the UE of bandwidth, antennas, scheduling timelines, or the like. The UE may communicate using the scheduling parameters during the active duration and switch to different scheduling parameters during the inactive duration. For example, the UE may transmit or receive characteristically periodic traffic, such as video traffic, during the active duration.

Particular aspects of the subject matter described in this disclosure can be implemented to realize one or more of the following potential advantages. In some examples, the described techniques can be used to reduce reliance on explicit signaling from the network for adaptation. As a result, time and frequency resources that would otherwise be occupied by DCI signaling may be allocated for other communications. Additionally, or alternatively, latency due to DCI signaling may decrease because minimum time windows for the UE to adapt one or more parameters in accordance with the DCI may be avoided.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

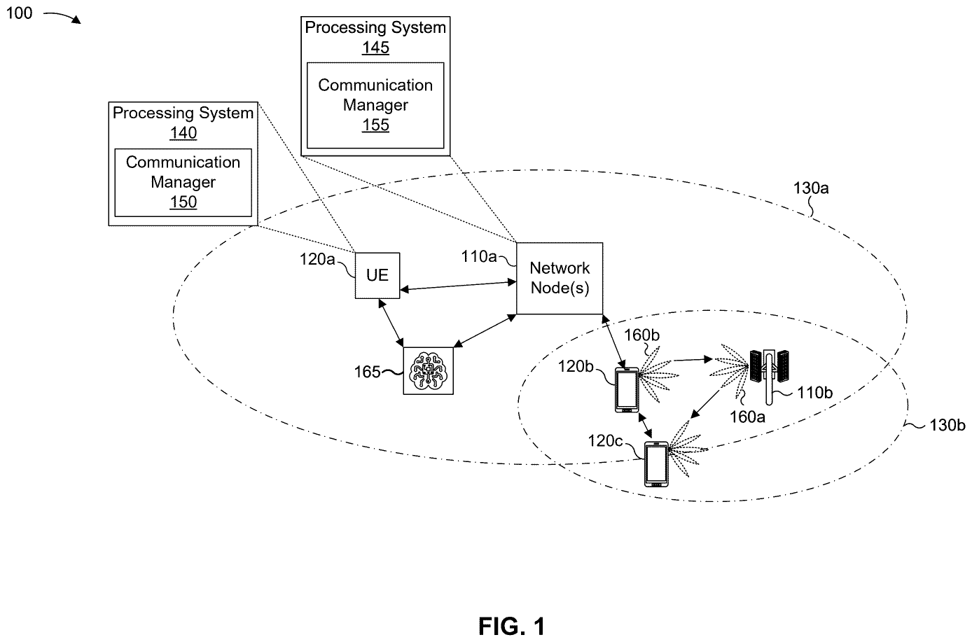

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive configuration information, the configuration information indicating periodically adapting one or more first scheduling parameters, the one or more first scheduling parameters associated with a configuration period, the configuration period including an active duration and an inactive duration; communicate, during the active duration, in accordance with the one or more first scheduling parameters; and communicate, during the inactive duration, in accordance with one or more second scheduling parameters that are different from the one or more first scheduling parameters. Additionally, or alternatively, the communication manager 150 may perform one or more other operations described herein.

In some aspects, the network node 110 may include a communication manager 155. As described in more detail elsewhere herein, the communication manager 155 may transmit configuration information, the configuration information indicating periodically adapting one or more first scheduling parameters, the one or more first scheduling parameters associated with a configuration period, the configuration period including an active duration and an inactive duration; communicate, during the active duration, in accordance with the one or more first scheduling parameters; and communicate, during the inactive duration, in accordance with one or more second scheduling parameters that are different from the one or more first scheduling parameters. Additionally, or alternatively, the communication manager 155 may perform one or more other operations described herein.

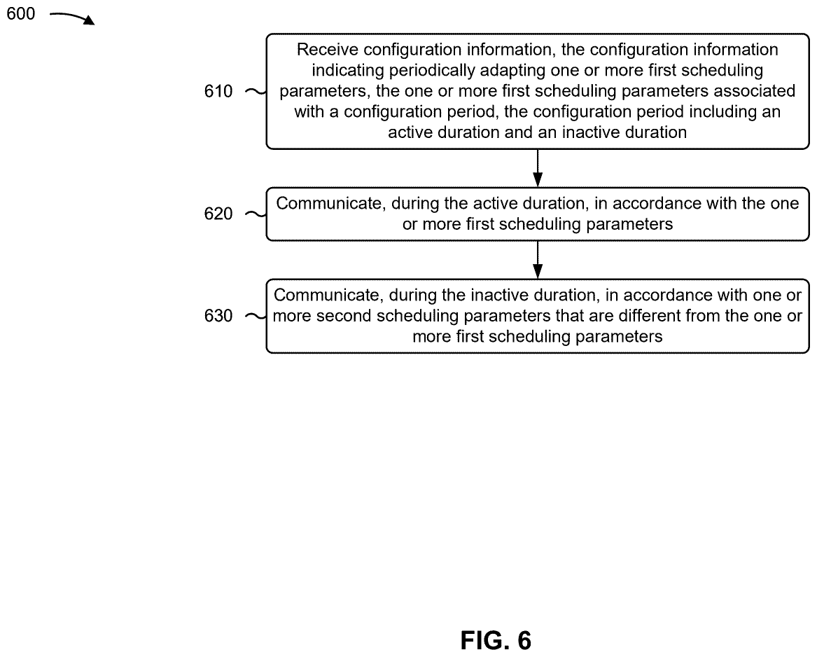

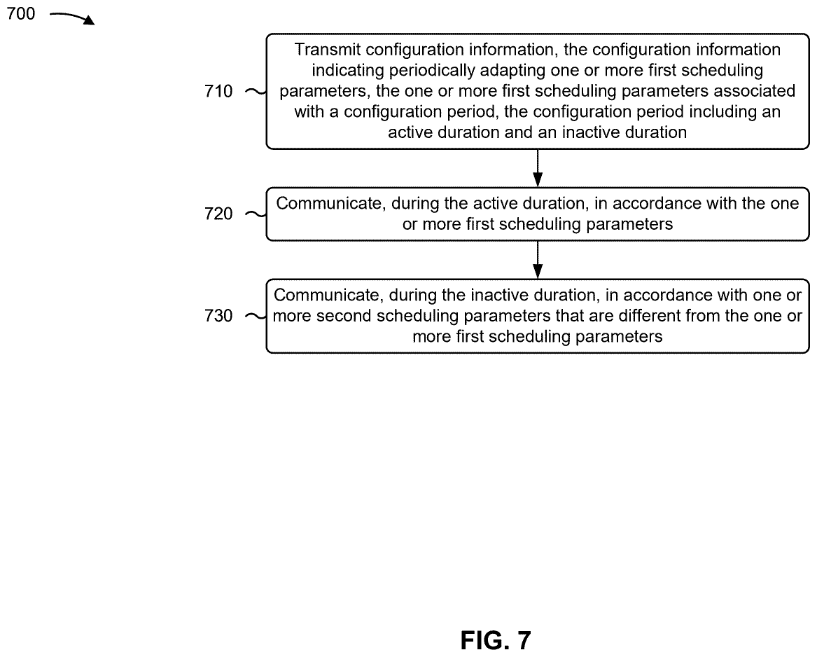

The network node 110, the processing system 145 of the network node 110, the UE 120, the processing system 140 of the UE 120, or any other component(s) of FIG. 1 may implement one or more techniques or perform one or more operations associated with periodic parameter adaptation configuration, as described in more detail elsewhere herein. For example, the processing system 145 of the network node 110, or the processing system 140 of the UE 120 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

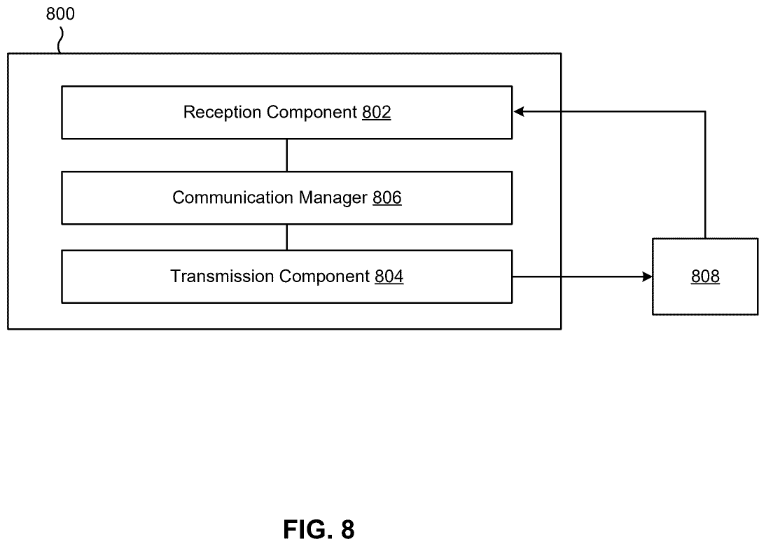

In some aspects, the UE 120 includes means for receiving configuration information, the configuration information indicating periodically adapting one or more first scheduling parameters, the one or more first scheduling parameters associated with a configuration period, the configuration period including an active duration and an inactive duration; means for communicating, during the active duration, in accordance with the one or more first scheduling parameters; or means for communicating, during the inactive duration, in accordance with one or more second scheduling parameters that are different from the one or more first scheduling parameters. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

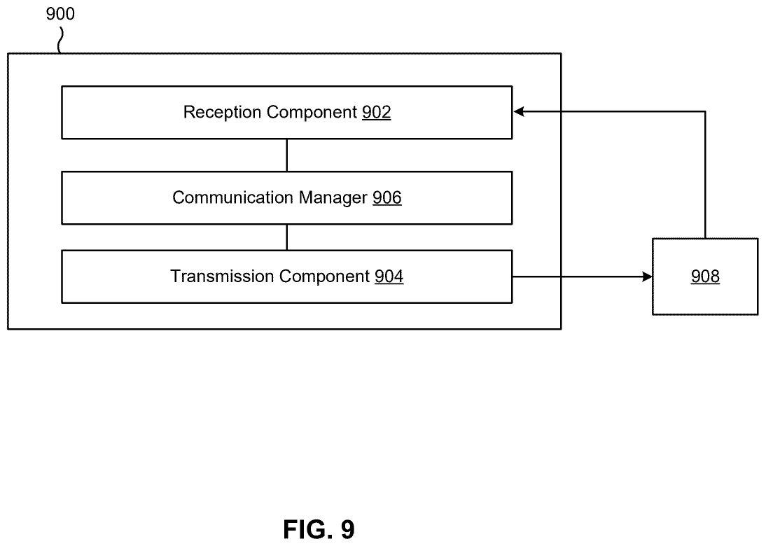

In some aspects, the network node 110 includes means for transmitting configuration information, the configuration information indicating periodically adapting one or more first scheduling parameters, the one or more first scheduling parameters associated with a configuration period, the configuration period including an active duration and an inactive duration; means for communicating, during the active duration, in accordance with the one or more first scheduling parameters; or means for communicating, during the inactive duration, in accordance with one or more second scheduling parameters that are different from the one or more first scheduling parameters. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

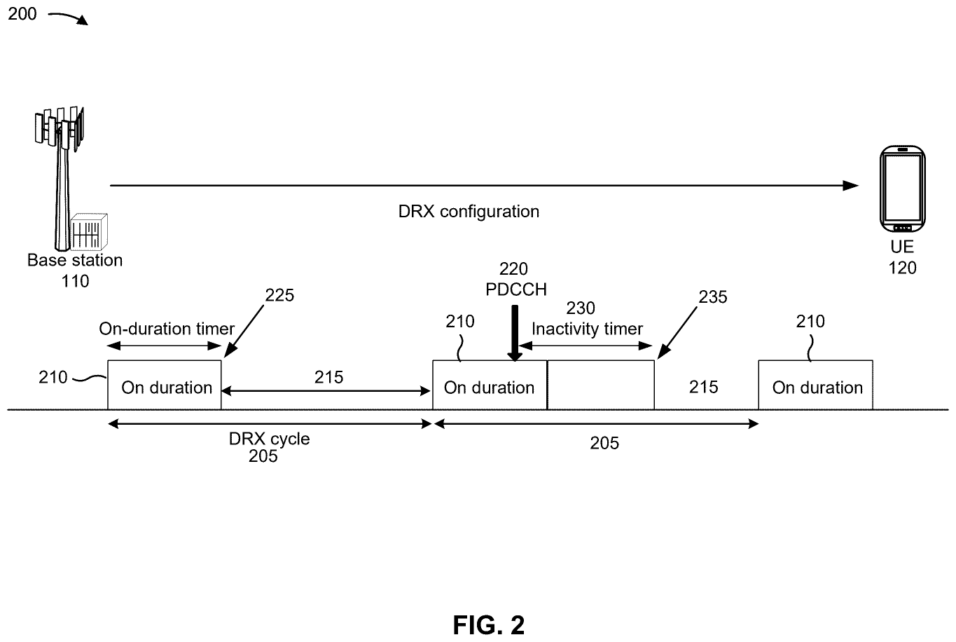

FIG. 2 is a diagram illustrating an example 200 of a discontinuous reception (DRX) configuration.

As shown in FIG. 2, a network node 110 may transmit a DRX configuration to a UE 120 to configure a DRX cycle 205 for the UE 120. A DRX cycle 205 (e.g., a DRX period) may include a DRX on duration 210 (e.g., during which a UE 120 is awake or in an active state) and an opportunity to enter a DRX sleep state 215. As used herein, the time during which the UE 120 is configured to be in an active state during the DRX on duration 210 may be referred to as an active time, and the time during which the UE 120 is configured to be in the DRX sleep state 215 may be referred to as an inactive time. As described below, the UE 120 may monitor a physical downlink control channel (PDCCH) during the active time, and may refrain from monitoring the PDCCH during the inactive time.

During the DRX on duration 210 (e.g., the active time), the UE 120 may monitor a downlink control channel (e.g., a PDCCH), as shown by reference number 220. For example, the UE 120 may monitor the PDCCH for downlink control information (DCI) pertaining to the UE 120. If the UE 120 does not detect or successfully decode any PDCCH communications intended for the UE 120 during the DRX on duration 210, then the UE 120 may enter the sleep state 215 (e.g., for the inactive time) at the end of the DRX on duration 210, as shown by reference number 225. In this way, the UE 120 may conserve battery power and reduce power consumption. As shown, the DRX cycle 205 may repeat with a configured periodicity according to the DRX configuration.

If the UE 120 detects or successfully decodes a PDCCH communication intended for the UE 120, then the UE 120 may remain in an active state (e.g., an awake state or a DRX-on state) for the duration of a DRX inactivity timer 230 (e.g., which may extend the active time). The UE 120 may start the DRX inactivity timer 230 at a time at which the PDCCH communication is received (e.g., in a transmission time interval (TTI) in which the PDCCH communication is received, such as a slot or a subframe). The UE 120 may remain in the active state until the DRX inactivity timer 230 expires, at which time the UE 120 may enter the sleep state 215 (e.g., a DRX-off state) for the inactive time, as shown by reference number 235. During the duration of the DRX inactivity timer 230, the UE 120 may continue to monitor for PDCCH communications, may obtain a downlink data communication (e.g., on a downlink data channel, such as a physical downlink shared channel (PDSCH)) scheduled by the PDCCH communication, or may prepare or transmit an uplink communication (e.g., on a physical uplink shared channel (PUSCH)) scheduled by the PDCCH communication. The UE 120 may restart the DRX inactivity timer 230 after each detection of a PDCCH communication for the UE 120 for an initial transmission (e.g., but not for a retransmission). By operating in this manner, the UE 120 may conserve battery power and reduce power consumption by entering the sleep state 215.

As indicated above, FIG. 2 is provided as an example. Other examples may differ from what is described with respect to FIG. 2.

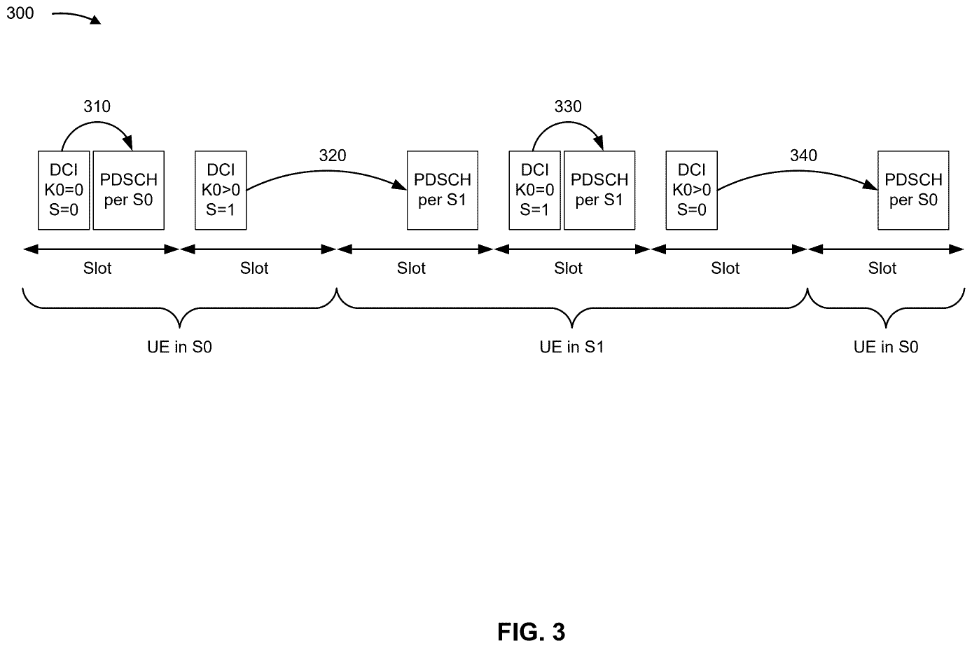

FIG. 3 is a diagram illustrating an example 300 of communication configuration adaptation.

Example 300 shows a timeline for switching between a first communication configuration (e.g., a first per-BWP communication configuration) and a second communication configuration (e.g., a second per-BWP communication configuration). The first communication configuration (“S0”) may low-power configuration, and the second communication configuration (“S1”) may be a high-power configuration (e.g., S0 may consume less power than S1). As shown by reference number 310, a first DCI communication may schedule a PDSCH communication with S0. As shown by reference number 320, a second DCI communication may schedule a PDSCH communication with S1. As shown by reference number 330, a third DCI communication may schedule another PDSCH communication with S1. As shown by reference number 340, a fourth DCI communication may schedule another PDSCH communication with S0. In some examples, PDCCH communications may remain decodable independent of the currently active communication configuration (e.g., the PDCCH may retain the same monitoring occasions, format, or the like).

Adaptation of UE configurations for communication configuration involves explicit DCI signaling. Other forms of adaptation, such as for BWPs, minimum scheduling offset parameter K0, or minimum scheduling offset parameter K2 (discussed above) may similarly involve explicit DCI signaling. However, using DCI signaling for every adaptation instance consumes overhead. For example, each DCI communication (as shown in connection with reference numbers 310-340) may consume one or more time and frequency resources. Moreover, the DCI communications may consume additional resources as the number of adaptations increases (e.g., as the UE continues to switch between S0 and S1). Additionally, or alternatively, DCI signaling may incur latency due to a minimum time window for the UE to adapt one or more parameters in accordance with the DCI (e.g., a minimum time window for the UE to switch between S0 and S1). Accordingly, techniques are described herein that reduce DCI signaling for adaptation.

As indicated above, FIG. 3 is provided as an example. Other examples may differ from what is described with respect to FIG. 3.

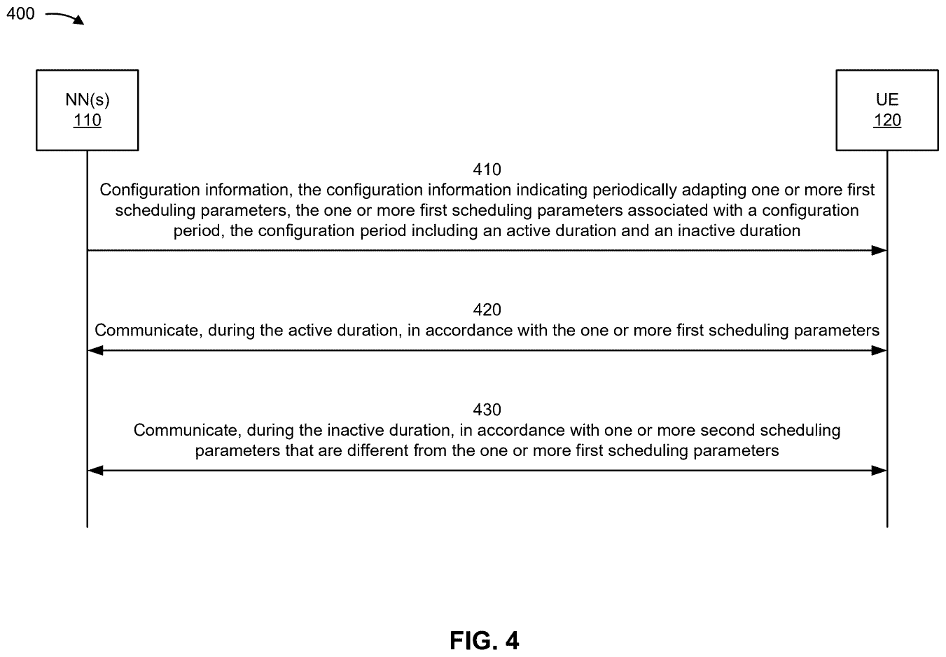

FIG. 4 is a diagram illustrating an example 400 associated with signaling for periodic parameter adaptation configuration. As shown in FIG. 4, a network node 110 and a UE 120 may communicate with one another.

As shown by reference number 410, the network node 110 may transmit, and the UE 120 may receive, configuration information that indicates periodically adapting one or more first scheduling parameters. The configuration information (e.g., a periodic configuration, a periodically active configuration, a periodic adaptation configuration, or the like) may specify settings for periodically adapting the one or more first scheduling parameters, such as a periodicity, the one or more first scheduling parameters, or the like. The one or more first scheduling parameters (e.g., a configuration profile, an active configuration profile, or the like) may indicate a time or frequency resource for a wireless communication or a signaling characteristic of the wireless communication. In some aspects, the one or more first scheduling parameters may be associated with a configuration period that includes an active duration and an inactive duration. The configuration period may be a length of time during which the UE 120 cycles through the active duration and the inactive duration. The active duration may be a length of time applied periodically to the UE 120 during which the UE 120 can transmit or receive wireless communications in accordance with the one or more first scheduling parameters. The inactive duration may be a length of time applied periodically to the UE 120 during which the UE 120 can transmit or receive wireless communications in accordance with other scheduling parameters. In some examples, different scheduling parameters or profile types may have respective periodic configurations, or a single periodic configuration may cover multiple scheduling parameters.

In some aspects, the one or more first scheduling parameters may include one or more of a BWP, a minimum scheduling offset, a maximum rank, a PDCCH monitoring periodicity, or a communication configuration. The BWP may be a block of frequency domain resources as described above. The minimum scheduling offset may include one or more of a minimum scheduling offset parameter K0 or a minimum scheduling offset parameter K2 as described above. The maximum rank may be a maximum RI (e.g., a maximum achievable performance of multiple antennas). The communication configuration (e.g., a light adaptation configuration profile) may be a per-BWP communication configuration as described above. The PDCCH monitoring periodicity may refer to regular intervals that include a PDCCH monitoring window, during which the UE 120 monitors a PDCCH.

In some aspects, the configuration information may include, or be included in, DRX configuration information. The DRX configuration information may specify DRX settings (e.g., a DRX cycle, an on duration, or the like) as discussed above. In some examples, the configuration information may be part of the DRX configuration information. In some aspects, a starting offset associated with the configuration information may be relative to a DRX on duration associated with the DRX configuration information. The starting offset may be associated with the configuration information in that the starting offset may indicate when the configuration period of the configuration information starts. The DRX on duration may be associated with the DRX configuration information in that the DRX configuration information may configure the DRX on duration. The starting offset may be relative to the DRX on duration in that the starting offset may be defined relative to a beginning of the DRX on duration.

In some aspects, the starting offset associated with the configuration information may be relative to a system frame. The system frame may be a length of time indexed by a system frame number (SFN). The starting offset may be relative to the system frame in that the starting offset may be defined relative to the system frame (e.g., a length of time before, during, or after the system frame). The starting offset may be relative to the system frame in examples where the configuration information is separate from DRX configuration information.

In some aspects, the configuration information may be deactivated based at least in part on one or more of a deactivation timer associated with the configuration information, or a wireless communication indicating that the configuration information is to be deactivated. The configuration information may be deactivated in that the UE 120 may refrain from transmitting or receiving communications in accordance with the configuration information (e.g., the UE 120 may refrain from transmitting or receiving communications in accordance with the active duration and the inactive duration). The deactivation timer may be associated with the configuration information in that an expiration of the deactivation timer may prompt deactivation of the configuration information. The wireless communication may explicitly indicate that the configuration information is to be deactivated.

In some aspects, the deactivation timer may be reset based at least in part on one or more of any DCI, a wireless communication indicating that the timer is to be reset, or DCI indicating a change in the configuration information. Resetting the deactivation timer may extend a length of time for which the configuration information remains active. In some examples, the deactivation timer may be reset any time the UE 120 receives DCI. Additionally, or alternatively, the deactivation timer may be reset in response to the wireless communication (e.g., in response to an explicit indication, from the network node 110, that the timer is to be reset), such as a MAC-CE or DCI. Additionally, or alternatively, the deactivation timer may be reset in response to the UE 120 receiving DCI indicating a change in the configuration information (e.g., an adjustment to, an addition to, or a removal of the one or more first scheduling parameters).

In some aspects, one or more of the starting offset associated with the configuration information, the active duration, or the deactivation timer associated with the configuration information may be configurable. For example, a duration of the starting offset, a duration of the active duration, or a duration of the deactivation timer may be configured. In some examples, the network node 110 may transmit, and the UE 120 may receive, configuration information (e.g., RRC signaling, a MAC-CE, or DCI) indicating the starting offset, the active duration, or the deactivation timer.

In some aspects, the configuration information may be activated based at least in part on one or more of the configuration information, a MAC-CE, or DCI. The configuration information may be activated in that the UE 120 may be enabled to transmit or receive communications in accordance with the configuration information. In some examples, the configuration information may be activated automatically upon reception of the configuration information (e.g., RRC signaling). Additionally, or alternatively, the configuration information may be activated in response to reception of the MAC-CE or the DCI.

In some aspects, the configuration information may be associated with a configuration identifier or a configuration index. The configuration information may be associated with the configuration identifier or the configuration index in that the configuration information may be identified by the configuration identifier or the configuration index. In some examples, the network node 110 may transmit, and the UE 120 may receive, RRC signaling, a MAC-CE, or DCI that indicates the configuration identifier or the configuration index. For example, the network node 110 may use the configuration identifier or the configuration index to indicate which configuration information is to be activated, deactivated, configured, re-configured, or the like.

In some aspects, the configuration information may be associated with a transition duration that is associated with a change in the configuration information. The change in the configuration information may be an active profile change (e.g., a change between periodic configurations). The transition duration may be a period of time during which the UE 120 transitions between periodic configurations. The transition duration may be associated with the change in the configuration information in that the transition duration may be defined before or after an active profile change. The configuration information may be associated with the transition duration in that the UE 120 may transition between the configuration information and other configuration information. In some examples, the network node 110 may transmit, and the UE 120 may receive, an indication of the transition duration.

In some aspects, the change in the configuration information may include a change in the one or more first scheduling parameters, and the transition duration may be based at least in part on the change in the one or more first scheduling parameters. For example, the transition duration may depend on the change in the one or more first scheduling parameters. For example, if the change in the one or more first scheduling parameters is a change in BWP, then the transition duration may track a BWP switching timeline. For example, a transition duration for a change in BWP may be larger than a transition duration for a change in a minimum scheduling offset.

In some aspects, the transition duration may be configurable or reported as a UE capability. For example, the UE 120 may transmit, and the network node 110 may receive, a UE capability report that indicates the transition duration (e.g., a minimum transition duration to which the UE 120 is capable of adhering). Additionally, or alternatively, the network node 110 may transmit, and the UE 120 may receive, an indication of the transition duration. For example, the network node 110 may transmit, and the UE 120 may receive, the indication of the transition duration based at least in part on the UE capability report indicating the transition duration.

In some aspects, a change in the configuration information may be UE-initiated. For example, the UE 120 may transmit, and the network node 110 may receive, an indication to change the configuration information. For example, the UE 120 may transmit, and the network node 110 may receive, an indication to transition between periodic configurations.

In some aspects, the change in the configuration information may be based at least in part on an SR or a NACK. For example, the UE 120 may transmit, and the network node 110 may receive, the SR or the NACK. The UE 120 may, responsive to transmitting the SR or the NACK, initiate the change the configuration information (e.g., transition between periodic configurations). In some examples, the UE 120 may refrain from transitioning between periodic configurations (e.g., and remain in a current state with the configuration information) if the UE 120 does not transmit an SR or a NACK.

In some aspects, an ability of the UE 120 to initiate the change in the configuration information may be configurable. For example, the network node 110 may transmit, and the UE 120 may receive, an indication that the ability of the UE 120 to initiate the change in the configuration information is enabled or disabled. If the UE 120 receives an indication that the ability of the UE 120 to initiate the change in the configuration information is enabled, then the UE 120 may initiate the change in the configuration information. If the UE 120 receives an indication that the ability of the UE 120 to initiate the change in the configuration information is disabled (or if the UE 120 does not receive an indication that the ability of the UE 120 to initiate the change in the configuration information is enabled), then the UE 120 may refrain from initiating the change in the configuration information.

In some aspects, the ability of the UE 120 to initiate the change in the configuration information may be associated with a subset of a set of scheduling parameters or a subset of a set of triggering events. The ability of the UE 120 to initiate the change in the configuration information may be associated with the subset of the set of scheduling parameters or the subset of the set of triggering events in that the ability of the UE 120 to initiate the change in the configuration information may be configured on a per-subset basis. For example, the network node 110 may enable or disable the ability of the UE 120 to initiate the change in the configuration information for a subset of the scheduling parameters (e.g., the one or more first scheduling parameters) or for a subset of the triggering events (e.g., SR transmission).

As shown by reference number 420, the network node 110 and the UE 120 may communicate, during the active duration, in accordance with the one or more first scheduling parameters. In some examples, the network node 110 may transmit, and the UE 120 may receive, one or more downlink communications that adhere to the one or more first scheduling parameters during the active duration. Additionally, or alternatively, the UE 120 may transmit, and the network node 110 may receive, one or more uplink communications that adhere to the one or more first scheduling parameters during the active duration. For example, the uplink or downlink communications may be communicated in the BWP, after the minimum scheduling offset, using a rank that is less than or equal to the maximum rank, during a PDCCH monitoring window defined by the PDCCH monitoring periodicity, or using one or more scheduling parameters (e.g., the first scheduling parameter(s)) that are configured as part of the communication configuration, among other examples.

As shown by reference number 430, the network node 110 and the UE 120 may communicate, during the inactive duration, in accordance with one or more second scheduling parameters that are different from the one or more first scheduling parameters. The one or more second scheduling parameters may indicate a time or frequency resource for a wireless communication or a signaling characteristic of the wireless communication. The one or more second scheduling parameters may be configured as another configuration profile, active configuration profile, or the like, or the one or more second scheduling parameters may include one or more default settings. In some examples, the network node 110 may transmit, and the UE 120 may receive, one or more downlink communications that adhere to the one or more second scheduling parameters during the inactive duration. Additionally, or alternatively, the UE 120 may transmit, and the network node 110 may receive, one or more uplink communications that adhere to the one or more second scheduling parameters during the inactive duration. For example, the uplink or downlink communications may be communicated in a BWP that differs from the BWP of the one or more first scheduling parameters; after a minimum scheduling offset that differs from the minimum scheduling offset of the one or more first scheduling parameters; using a rank that is less than or equal to a maximum rank that differs from the maximum rank of the one or more first scheduling parameters, during a PDCCH monitoring window defined by a PDCCH monitoring periodicity that differs from the PDCCH monitoring periodicity of the one or more first scheduling parameters; or using one or more scheduling parameters (e.g., the second scheduling parameter(s)) that are configured as part of a communication configuration that differs from the communication configuration of the one or more first scheduling parameters, among other examples.

As indicated above, FIG. 4 is provided as an example. Other examples may differ from what is described with respect to FIG. 4.

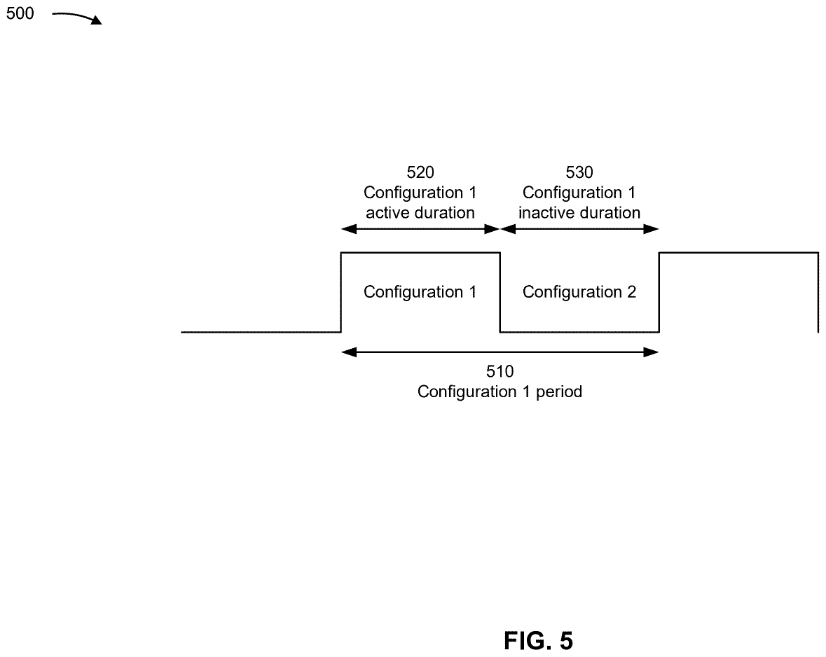

FIG. 5 is a diagram illustrating an example 500 associated with periodic parameter adaptation configuration.

In example 500, the UE 120 may periodically switch between scheduling parameters associated with a first configuration (“configuration 1”) and a second configuration (“configuration 2”). The timing of the periodic switching may be dictated by a configuration period 510 of the first configuration. As shown, the configuration period 510 may include an active duration 520 of the first configuration and an inactive duration 530 of the first configuration. During the active duration 520, the UE 120 may transmit or receive wireless communications in accordance with the one or more first scheduling parameters of the first configuration. During the inactive duration 530, the UE 120 may transmit or receive wireless communications in accordance with one or more second scheduling parameters of the second configuration.

As indicated above, FIG. 5 is provided as an example. Other examples may differ from what is described with respect to FIG. 5.

The configuration information indicating periodically adapting one or more first scheduling parameters, the one or more first scheduling parameters being associated with a configuration period, and the configuration period including an active duration and an inactive duration may help to reduce reliance on explicit signaling from the network node 110 for adaptation. As a result, time and frequency resources that would otherwise be occupied by DCI signaling may be allocated for other communications. Additionally, or alternatively, latency due to DCI signaling may decrease because minimum time windows for the UE 120 to adapt one or more parameters in accordance with the DCI may be avoided.

FIG. 6 is a diagram illustrating an example process 600 performed, for example, at a UE or an apparatus of a UE. Example process 600 is an example where the apparatus or the UE (e.g., UE 120) performs operations associated with periodic parameter adaptation configuration.

As shown in FIG. 6, in some aspects, process 600 may include receiving configuration information, the configuration information indicating periodically adapting one or more first scheduling parameters, the one or more first scheduling parameters associated with a configuration period, the configuration period including an active duration and an inactive duration (block 610). For example, the UE (e.g., using reception component 802 or communication manager 806, depicted in FIG. 8) may receive configuration information, the configuration information indicating periodically adapting one or more first scheduling parameters, the one or more first scheduling parameters associated with a configuration period, the configuration period including an active duration and an inactive duration, as described above.

As further shown in FIG. 6, in some aspects, process 600 may include communicating, during the active duration, in accordance with the one or more first scheduling parameters (block 620). For example, the UE (e.g., using reception component 802, transmission component 804, or communication manager 806, depicted in FIG. 8) may communicate, during the active duration, in accordance with the one or more first scheduling parameters, as described above.

As further shown in FIG. 6, in some aspects, process 600 may include communicating, during the inactive duration, in accordance with one or more second scheduling parameters that are different from the one or more first scheduling parameters (block 630). For example, the UE (e.g., using reception component 802, transmission component 804, or communication manager 806, depicted in FIG. 8) may communicate, during the inactive duration, in accordance with one or more second scheduling parameters that are different from the one or more first scheduling parameters, as described above.

Process 600 may include additional aspects, such as any single aspect or any combination of aspects described below or in connection with one or more other processes described elsewhere herein.

In a first aspect, the one or more first scheduling parameters include one or more of a bandwidth part, a minimum scheduling offset, a maximum rank, a PDCCH monitoring periodicity, or a communication configuration.

In a second aspect, alone or in combination with the first aspect, the configuration information comprises DRX configuration information, and a starting offset associated with the configuration information is relative to a DRX on duration associated with the DRX configuration information.

In a third aspect, alone or in combination with one or more of the first and second aspects, a starting offset associated with the configuration information is relative to a system frame.

In a fourth aspect, alone or in combination with one or more of the first through third aspects, the configuration information is deactivated based at least in part on one or more of a deactivation timer associated with the configuration information, or a wireless communication indicating that the configuration information is to be deactivated.

In a fifth aspect, alone or in combination with one or more of the first through fourth aspects, the deactivation timer is reset based at least in part on one or more of any DCI, a wireless communication indicating that the timer is to be reset, or DCI indicating a change in the configuration information.

In a sixth aspect, alone or in combination with one or more of the first through fifth aspects, one or more of a starting offset associated with the configuration information, the active duration, or a deactivation timer associated with the configuration information are configurable.

In a seventh aspect, alone or in combination with one or more of the first through sixth aspects, the configuration information is activated based at least in part on one or more of the configuration information, a MAC-CE, or DCI.

In an eighth aspect, alone or in combination with one or more of the first through seventh aspects, the configuration information is associated with a configuration identifier or a configuration index.

In a ninth aspect, alone or in combination with one or more of the first through eighth aspects, the configuration information is associated with a transition duration that is associated with a change in the configuration information.

In a tenth aspect, alone or in combination with one or more of the first through ninth aspects, the change in the configuration information comprises a change in the one or more first scheduling parameters, and the transition duration is based at least in part on the change in the one or more first scheduling parameters.

In an eleventh aspect, alone or in combination with one or more of the first through tenth aspects, the transition duration is configurable or reported as a UE capability.

In a twelfth aspect, alone or in combination with one or more of the first through eleventh aspects, a change in the configuration information is UE-initiated.

In a thirteenth aspect, alone or in combination with one or more of the first through twelfth aspects, the change in the configuration information is based at least in part on a scheduling request or a negative acknowledgment.

In a fourteenth aspect, alone or in combination with one or more of the first through thirteenth aspects, an ability of the UE to initiate the change in the configuration information is configurable.

In a fifteenth aspect, alone or in combination with one or more of the first through fourteenth aspects, the ability of the UE to initiate the change in the configuration information is associated with a subset of a set of scheduling parameters or a subset of a set of triggering events.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with periodic parameter adaptation configuration.

As shown in FIG. 7, in some aspects, process 700 may include transmitting configuration information, the configuration information indicating periodically adapting one or more first scheduling parameters, the one or more first scheduling parameters associated with a configuration period, the configuration period including an active duration and an inactive duration (block 710). For example, the network node (e.g., using transmission component 904 or communication manager 906, depicted in FIG. 9) may transmit configuration information, the configuration information indicating periodically adapting one or more first scheduling parameters, the one or more first scheduling parameters associated with a configuration period, the configuration period including an active duration and an inactive duration, as described above.

As further shown in FIG. 7, in some aspects, process 700 may include communicating, during the active duration, in accordance with the one or more first scheduling parameters (block 720). For example, the network node (e.g., using reception component 902, transmission component 904, or communication manager 906, depicted in FIG. 9) may communicate, during the active duration, in accordance with the one or more first scheduling parameters, as described above.

As further shown in FIG. 7, in some aspects, process 700 may include communicating, during the inactive duration, in accordance with one or more second scheduling parameters that are different from the one or more first scheduling parameters (block 730). For example, the network node (e.g., using reception component 902, transmission component 904, or communication manager 906, depicted in FIG. 9) may communicate, during the inactive duration, in accordance with one or more second scheduling parameters that are different from the one or more first scheduling parameters, as described above.

Process 700 may include additional aspects, such as any single aspect or any combination of aspects described below or in connection with one or more other processes described elsewhere herein.

In a first aspect, the one or more first scheduling parameters include one or more of a bandwidth part, a minimum scheduling offset, a maximum rank, a PDCCH monitoring periodicity, or a communication configuration.

In a second aspect, alone or in combination with the first aspect, the configuration information comprises DRX configuration information, and a starting offset associated with the configuration information is relative to a DRX on duration associated with the DRX configuration information.

In a third aspect, alone or in combination with one or more of the first and second aspects, a starting offset associated with the configuration information is relative to a system frame.

In a fourth aspect, alone or in combination with one or more of the first through third aspects, the configuration information is deactivated based at least in part on one or more of a deactivation timer associated with the configuration information, or a wireless communication indicating that the configuration information is to be deactivated.

In a fifth aspect, alone or in combination with one or more of the first through fourth aspects, the deactivation timer is reset based at least in part on one or more of any DCI, a wireless communication indicating that the timer is to be reset, or DCI indicating a change in the configuration information.

In a sixth aspect, alone or in combination with one or more of the first through fifth aspects, one or more of a starting offset associated with the configuration information, the active duration, or a deactivation timer associated with the configuration information are configurable.

In a seventh aspect, alone or in combination with one or more of the first through sixth aspects, the configuration information is activated based at least in part on one or more of the configuration information, a MAC-CE, or DCI.

In an eighth aspect, alone or in combination with one or more of the first through seventh aspects, the configuration information is associated with a configuration identifier or a configuration index.

In a ninth aspect, alone or in combination with one or more of the first through eighth aspects, the configuration information is associated with a transition duration that is associated with a change in the configuration information.

In a tenth aspect, alone or in combination with one or more of the first through ninth aspects, the change in the configuration information comprises a change in the one or more first scheduling parameters, and the transition duration is based at least in part on the change in the one or more first scheduling parameters.

In an eleventh aspect, alone or in combination with one or more of the first through tenth aspects, the transition duration is configurable or reported as a UE capability.

In a twelfth aspect, alone or in combination with one or more of the first through eleventh aspects, a change in the configuration information is UE-initiated.

In a thirteenth aspect, alone or in combination with one or more of the first through twelfth aspects, the change in the configuration information is based at least in part on a scheduling request or a negative acknowledgment.

In a fourteenth aspect, alone or in combination with one or more of the first through thirteenth aspects, an ability of a UE to initiate the change in the configuration information is configurable.

In a fifteenth aspect, alone or in combination with one or more of the first through fourteenth aspects, the ability of the UE to initiate the change in the configuration information is associated with a subset of a set of scheduling parameters or a subset of a set of triggering events.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive configuration information, the configuration information indicating periodically adapting one or more first scheduling parameters, the one or more first scheduling parameters associated with a configuration period, the configuration period including an active duration and an inactive duration. The reception component 802 or the transmission component 804 may communicate, during the active duration, in accordance with the one or more first scheduling parameters. The reception component 802 or the transmission component 804 may communicate, during the inactive duration, in accordance with one or more second scheduling parameters that are different from the one or more first scheduling parameters.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4-5. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit configuration information, the configuration information indicating periodically adapting one or more first scheduling parameters, the one or more first scheduling parameters associated with a configuration period, the configuration period including an active duration and an inactive duration. The reception component 902 or the transmission component 904 may communicate, during the active duration, in accordance with the one or more first scheduling parameters. The reception component 902 or the transmission component 904 may communicate, during the inactive duration, in accordance with one or more second scheduling parameters that are different from the one or more first scheduling parameters.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving configuration information, the configuration information indicating periodically adapting one or more first scheduling parameters, the one or more first scheduling parameters associated with a configuration period, the configuration period including an active duration and an inactive duration; communicating, during the active duration, in accordance with the one or more first scheduling parameters; and communicating, during the inactive duration, in accordance with one or more second scheduling parameters that are different from the one or more first scheduling parameters.

Aspect 2: The method of Aspect 1, wherein the one or more first scheduling parameters include one or more of: a bandwidth part, a minimum scheduling offset, a maximum rank, a physical downlink control channel (PDCCH) monitoring periodicity, or a communication configuration.

Aspect 3: The method of any of Aspects 1-2, wherein the configuration information comprises discontinuous reception (DRX) configuration information, and a starting offset associated with the configuration information is relative to a DRX on duration associated with the DRX configuration information.

Aspect 4: The method of any of Aspects 1-3, wherein a starting offset associated with the configuration information is relative to a system frame.

Aspect 5: The method of any of Aspects 1-4, wherein the configuration information is deactivated based at least in part on one or more of a deactivation timer associated with the configuration information, or a wireless communication indicating that the configuration information is to be deactivated.

Aspect 6: The method of Aspect 5, wherein the deactivation timer is reset based at least in part on one or more of: any downlink control information (DCI), a wireless communication indicating that the timer is to be reset, or DCI indicating a change in the configuration information.

Aspect 7: The method of any of Aspects 1-6, wherein one or more of a starting offset associated with the configuration information, the active duration, or a deactivation timer associated with the configuration information are configurable.

Aspect 8: The method of any of Aspects 1-7, wherein the configuration information is activated based at least in part on one or more of: the configuration information, a medium access control (MAC) control element (MAC-CE), or downlink control information (DCI).

Aspect 9: The method of any of Aspects 1-8, wherein the configuration information is associated with a configuration identifier or a configuration index.

Aspect 10: The method of any of Aspects 1-9, wherein the configuration information is associated with a transition duration that is associated with a change in the configuration information.

Aspect 11: The method of Aspect 10, wherein the change in the configuration information comprises a change in the one or more first scheduling parameters, and the transition duration is based at least in part on the change in the one or more first scheduling parameters.

Aspect 12: The method of Aspect 10, wherein the transition duration is configurable or reported as a UE capability.

Aspect 13: The method of any of Aspects 1-12, wherein a change in the configuration information is UE-initiated.

Aspect 14: The method of Aspect 13, wherein the change in the configuration information is based at least in part on a scheduling request or a negative acknowledgment.

Aspect 15: The method of Aspect 13, wherein an ability of the UE to initiate the change in the configuration information is configurable.

Aspect 16: The method of Aspect 15, wherein the ability of the UE to initiate the change in the configuration information is associated with a subset of a set of scheduling parameters or a subset of a set of triggering events.

Aspect 17: A method of wireless communication performed by a network node, comprising: transmitting configuration information, the configuration information indicating periodically adapting one or more first scheduling parameters, the one or more first scheduling parameters associated with a configuration period, the configuration period including an active duration and an inactive duration; communicating, during the active duration, in accordance with the one or more first scheduling parameters; and communicating, during the inactive duration, in accordance with one or more second scheduling parameters that are different from the one or more first scheduling parameters.

Aspect 18: The method of Aspect 17, wherein the one or more first scheduling parameters include one or more of: a bandwidth part, a minimum scheduling offset, a maximum rank, a physical downlink control channel (PDCCH) monitoring periodicity, or a communication configuration.

Aspect 19: The method of any of Aspects 17-18, wherein the configuration information comprises discontinuous reception (DRX) configuration information, and a starting offset associated with the configuration information is relative to a DRX on duration associated with the DRX configuration information.

Aspect 20: The method of any of Aspects 17-19, wherein a starting offset associated with the configuration information is relative to a system frame.

Aspect 21: The method of any of Aspects 17-20, wherein the configuration information is deactivated based at least in part on one or more of a deactivation timer associated with the configuration information, or a wireless communication indicating that the configuration information is to be deactivated.

Aspect 22: The method of Aspect 21, wherein the deactivation timer is reset based at least in part on one or more of: any downlink control information (DCI), a wireless communication indicating that the timer is to be reset, or DCI indicating a change in the configuration information.

Aspect 23: The method of any of Aspects 17-22, wherein one or more of a starting offset associated with the configuration information, the active duration, or a deactivation timer associated with the configuration information are configurable.

Aspect 24: The method of any of Aspects 17-23, wherein the configuration information is activated based at least in part on one or more of: the configuration information, a medium access control (MAC) control element (MAC-CE), or downlink control information (DCI).

Aspect 25: The method of any of Aspects 17-24, wherein the configuration information is associated with a configuration identifier or a configuration index.

Aspect 26: The method of any of Aspects 17-25, wherein the configuration information is associated with a transition duration that is associated with a change in the configuration information.

Aspect 27: The method of Aspect 26, wherein the change in the configuration information comprises a change in the one or more first scheduling parameters, and the transition duration is based at least in part on the change in the one or more first scheduling parameters.

Aspect 28: The method of Aspect 26, wherein the transition duration is configurable or reported as a user equipment capability.

Aspect 29: The method of any of Aspects 17-28, wherein a change in the configuration information is user-equipment-initiated.

Aspect 30: The method of Aspect 29, wherein the change in the configuration information is based at least in part on a scheduling request or a negative acknowledgment.

Aspect 31: The method of Aspect 29, wherein an ability of a user equipment (UE) to initiate the change in the configuration information is configurable.

Aspect 32: The method of Aspect 31, wherein the ability of the UE to initiate the change in the configuration information is associated with a subset of a set of scheduling parameters or a subset of a set of triggering events.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

Aspect 40: A device comprising a processing system that includes one or more processors and one or more code-storing memories coupled with the one or more processors, the processing system configured to cause the device to perform the method of one or more of Aspects 1-32.

Aspect 41: A device comprising a processing system that includes processor circuitry and code-storing memory circuitry, the processing system configured to cause the device to perform the method of one or more of Aspects 1-32.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes processor circuitry and code-storing memory circuitry, the processing system configured to cause the UE to:
receive configuration information, the configuration information indicating periodically adapting one or more first scheduling parameters, the one or more first scheduling parameters associated with a configuration period, the configuration period including an active duration and an inactive duration;
communicate, during the active duration, in accordance with the one or more first scheduling parameters; and
communicate, during the inactive duration, in accordance with one or more second scheduling parameters that are different from the one or more first scheduling parameters.

2. The UE of claim 1, wherein the one or more first scheduling parameters include one or more of:
a bandwidth part,
a minimum scheduling offset,
a maximum rank,
a physical downlink control channel (PDCCH) monitoring periodicity, or
a communication configuration.

3. The UE of claim 1, wherein the configuration information comprises discontinuous reception (DRX) configuration information, and a starting offset associated with the configuration information is relative to a DRX on duration associated with the DRX configuration information.

4. The UE of claim 1, wherein a starting offset associated with the configuration information is relative to a system frame.

5. The UE of claim 1, wherein the configuration information is deactivated based at least in part on one or more of a deactivation timer associated with the configuration information, or a wireless communication indicating that the configuration information is to be deactivated.

6. The UE of claim 5, wherein the deactivation timer is reset based at least in part on one or more of:
any downlink control information (DCI),
a wireless communication indicating that the timer is to be reset, or
DCI indicating a change in the configuration information.

7. The UE of claim 1, wherein one or more of a starting offset associated with the configuration information, the active duration, or a deactivation timer associated with the configuration information are configurable.

8. The UE of claim 1, wherein the configuration information is activated based at least in part on one or more of:
the configuration information,
a medium access control (MAC) control element (MAC-CE), or
downlink control information (DCI).

9. The UE of claim 1, wherein the configuration information is associated with a configuration identifier or a configuration index.

10. The UE of claim 1, wherein the configuration information is associated with a transition duration that is associated with a change in the configuration information.

11. The UE of claim 10, wherein the change in the configuration information comprises a change in the one or more first scheduling parameters, and the transition duration is based at least in part on the change in the one or more first scheduling parameters.

12. The UE of claim 10, wherein the transition duration is configurable or reported as a UE capability.

13. The UE of claim 1, wherein a change in the configuration information is UE-initiated.

14. The UE of claim 13, wherein the change in the configuration information is based at least in part on a scheduling request or a negative acknowledgment.

15. The UE of claim 13, wherein an ability of the UE to initiate the change in the configuration information is configurable.

16. The UE of claim 15, wherein the ability of the UE to initiate the change in the configuration information is associated with a subset of a set of scheduling parameters or a subset of a set of triggering events.

17. A method of wireless communication performed by a user equipment (UE), comprising:
receiving configuration information, the configuration information indicating periodically adapting one or more first scheduling parameters, the one or more first scheduling parameters associated with a configuration period, the configuration period including an active duration and an inactive duration;
communicating, during the active duration, in accordance with the one or more first scheduling parameters; and
communicating, during the inactive duration, in accordance with one or more second scheduling parameters that are different from the one or more first scheduling parameters.

18. The method of claim 17, wherein the one or more first scheduling parameters include one or more of:
a bandwidth part,
a minimum scheduling offset,
a maximum rank,
a physical downlink control channel (PDCCH) monitoring periodicity, or
a communication configuration.

19. The method of claim 17, wherein the configuration information comprises discontinuous reception (DRX) configuration information, and a starting offset associated with the configuration information is relative to a DRX on duration associated with the DRX configuration information.

20. The method of claim 17, wherein a starting offset associated with the configuration information is relative to a system frame.

21. The method of claim 17, wherein the configuration information is deactivated based at least in part on one or more of a deactivation timer associated with the configuration information, or a wireless communication indicating that the configuration information is to be deactivated.

22. The method of claim 21, wherein the deactivation timer is reset based at least in part on one or more of:
any downlink control information (DCI),
a wireless communication indicating that the timer is to be reset, or
DCI indicating a change in the configuration information.

23. The method of claim 17, wherein one or more of a starting offset associated with the configuration information, the active duration, or a deactivation timer associated with the configuration information are configurable.

24. The method of claim 17, wherein the configuration information is activated based at least in part on one or more of:
the configuration information,
a medium access control (MAC) control element (MAC-CE), or
downlink control information (DCI).

25. The method of claim 17, wherein the configuration information is associated with a configuration identifier or a configuration index.

26. The method of claim 17, wherein the configuration information is associated with a transition duration that is associated with a change in the configuration information.

27. The method of claim 26, wherein the change in the configuration information comprises a change in the one or more first scheduling parameters, and the transition duration is based at least in part on the change in the one or more first scheduling parameters.

28. The method of claim 26, wherein the transition duration is configurable or reported as a UE capability.

29. An apparatus for wireless communication, comprising:
means for receiving configuration information, the configuration information indicating periodically adapting one or more first scheduling parameters, the one or more first scheduling parameters associated with a configuration period, the configuration period including an active duration and an inactive duration;
means for communicating, during the active duration, in accordance with the one or more first scheduling parameters; and
means for communicating, during the inactive duration, in accordance with one or more second scheduling parameters that are different from the one or more first scheduling parameters.

30. A non-transitory computer-readable medium storing a set of instructions for wireless communication, the set of instructions comprising:
one or more instructions that, when executed by one or more processors of a user equipment (UE), cause the UE to:
receive configuration information, the configuration information indicating periodically adapting one or more first scheduling parameters, the one or more first scheduling parameters associated with a configuration period, the configuration period including an active duration and an inactive duration;
communicate, during the active duration, in accordance with the one or more first scheduling parameters; and
communicate, during the inactive duration, in accordance with one or more second scheduling parameters that are different from the one or more first scheduling parameters.
